(19) United States
(12) Patent Application Publication
(10) Pub. No.: US 2019/0218996 A1
(43) Pub. Date: Jul. 18, 2019

(54) PISTON AND MANUFACTURING METHOD THEREOF

(71) Applicant: HONDA MOTOR CO., LTD., Tokyo (JP)

(72) Inventors: Takamasa MORI, Tokyo (JP); Takayuki SHIMOYAMADA, Tokyo (JP); Kazushige IWASAKI, Wako-shi (JP)

(73) Assignee: Honda Motor Co., Ltd., Tokyo (JP)

(21) Appl. No.: 16/301,612

(22) PCT Filed: Feb. 28, 2017
(86) PCT No.: PCT/JP2017/007934

§ 371 Date: Nov. 14, 2018

(30) Foreign Application Priority Data
May 27, 2016 (JP) 2016106335

(51) Int. Cl. F02F 3/00; F02F 3/26; F02F 3/20

(52) U.S. Cl. CPC F02F 3/0015; F02F 3/20; F02F 3/26; F02F 3/0084

(57) ABSTRACT

A piston manufactured by combining different materials which is free from the problem of interfacial fracture in the interface between the different materials, and a manufacturing method for such a piston. The piston of an internal combustion engine includes a first portion containing a first material, a second portion containing a second material different from the first material, and a boundary portion containing both the first material and the second material, and joining the first portion and the second portion to each other by being provided between the first portion and the second portion by a prescribed thickness, wherein a composition ratio of the first material progressively decreases and a composition ratio of the second material progressively increases in the boundary portion from a side of the first portion to a side of the second portion. The boundary portion may be made by a layered additive manufacturing method.

### TECHNICAL FIELD

The present invention relates to a piston of an internal combustion engine and a manufacturing method thereof.

### BACKGROUND ART

In consideration of stiffness, weight minimization, heat resistance, and cooling loss, it is known in conjunction with pistons for internal combustion engines to form different parts of a piston from different materials (see Patent Documents 1 to 3). Typically, a crown portion is made of an iron-base material for the purpose of improving the heat resistance and the stiffness and reducing the cooling loss, and skirt portions are made of an aluminum-base material for minimizing the weight. The iron-base material and the aluminum-base material are joined together by forging, friction stir welding, or lamination of one material on the other.

### PRIOR ART DOCUMENT(S)

### Patent Document(s)

Patent Document 1: US2014/0299091A1

Patent Document 2: JPH09-310639A

Patent Document 3: JP2010-005687A

### SUMMARY OF INVENTION

### Problem to be Solved by Invention

However, at the interface where the different materials are bonded to each other, interfacial fracture may occur due to the difference between the thermal expansion coefficients of the two materials.

In view of such a problem of the prior art, a primary object of the present invention is to provide a piston manufactured by combining different materials which is free from the problem of interfacial fracture in the interface between the different materials.

### Means to Solve Problem

To achieve such an object, a certain aspect of the present invention provides a piston (1) of an internal combustion engine, comprising: a first portion (20, 20, 21) containing a first material, a second portion (21, 25) containing a second material different from the first material, and a boundary portion (22, 26, 27) containing both the first material and the second material and provided between the first portion and the second portion by a prescribed thickness to join the first portion and the second portion to each other, wherein a composition ratio of the first material progressively decreases and a composition ratio of the second material progressively increases in the boundary portion from a side of the first portion to a side of the second portion.

According to this aspect of the present invention, since the composition ratios of the first material and the second material progressively change in the boundary portion provided between the first portion and the second portion, the stress that is caused by the difference between the thermal expansion coefficients of the first material and the second material is minimized. As a result, interfacial fracture can be minimized.

In this arrangement, preferably, the composition ratio of the first material progressively and continuously decreases and the composition ratio of the second material progressively and continuously increases in the boundary portion from the side of the first portion to the side of the second portion. Also, it may be arranged such that the composition ratio of the first material progressively and linearly decreases and the composition ratio of the second material progressively and linearly increases in the boundary portion from the side of the first portion to the side of the second portion.

Thereby, the transition of the composition ratios of the first material and the second material is so smooth that the stress owing to the difference in the thermal expansion coefficient can be minimized.

Alternatively, it may be arranged such that the composition ratio of the first material progressively decreases in a stepwise fashion and the composition ratio of the second material progressively increases in a stepwise fashion in the boundary portion from the side of the first portion to the side of the second portion.

Thereby, the forming of the boundary portion is simplified.

In any of such arrangements, preferably, the first material is an iron-base material and the second material is an aluminum-base material.

By using the iron-base material for a high temperature portion and a sliding portion of the piston, the stiffness, the heat resistance, and the wear resistance thereof can be improved. By using the aluminum-base material for a low temperature part of the piston, weight reduction can be achieved.

In any of such arrangements, it may be arranged such that the first material is an aluminum-base material or an iron-base material, and the second material is a resin material.

By using the aluminum-base material or the iron-base material for a high temperature portion and a sliding portion of the piston, the stiffness, the heat resistance, and the wear resistance thereof can be improved. By using the resin material for a low temperature part of the piston, weight reduction can be achieved.

Further, in any of such arrangements, preferably, the first portion is provided in a part of the piston on a side of a combustion chamber with respect an axial direction thereof, and the second portion is provided in a part of the piston on a side remote from the combustion chamber with respect to the axial direction thereof.

Thus, a high temperature portion of the piston is formed by the material having a high stiffness and a high heat resistance, and a low temperature portion of the piston is formed by the material having a smaller weight.

In any of such arrangements, preferably, the first portion is provided in a radially outer part of the piston, and the second portion is provided in a radially more inner part of the piston than the first portion.

Thereby, a part of the piston in sliding contact with a cylinder wall surface is made of the material having a high wear resistance, and a part of the piston not in sliding contact with a cylinder wall surface is made of the material having a light weight.

Another aspect of the present invention provides a piston (1) of an internal combustion engine, comprising: a crown portion (2) defining a lower end of a combustion chamber, a pair of pin boss portions (3) projecting from the crown portion away from the combustion chamber, and receiving a piston pin, and a pair of skirt portions (4) projecting from the crown portion away from the combustion chamber, and connected to the corresponding pin boss portions, wherein the piston includes an iron-base portion (20) containing an iron-base material, an aluminum-base portion (21) containing an aluminum-base material, and an iron-aluminum boundary portion (22) containing both the iron-base material and the aluminum-base material and provided between the iron-base portion and the aluminum-base portion by a prescribed thickness to join the iron-base portion and the aluminum-base portion to each other, and wherein a composition ratio of the iron-base material progressively decreases and a composition ratio of the aluminum-base material progressively increases in the boundary portion from a side of the iron-base portion to a side of the aluminum-base portion, the iron-base portion forming at least a part of the crown portion, the aluminum-base portion forming at least a part of the skirt portions.

According to this aspect of the present invention, since the crown portion which is subjected to a relatively high temperature in comparison to other parts of the piston is made of the iron-base material, the stiffness, the heat resistance, and the wear resistance of the piston are improved, and the cooling loss is reduced. Since the skirt portions which are subjected to a relatively low temperature as compared to other parts of the piston is made of the aluminum-base material, the weight can be reduced.

Preferably, the iron-base portion comprises a part of the crown portion defining the combustion chamber.

Since the part of the piston which is heated to a most high temperature among other parts of the piston is made of the iron-base material, the stiffness, the heat resistance, and the wear resistance of the piston are improved, and the cooling loss is reduced. In particular, the height of the top land of the piston can be minimized so that the surface area of the outer circumferential surface of the top land of the piston is reduced, and hence, the surface area of the part of the piston exposed to the combustion chamber can be minimized. As a result, heat transfer from the combustion gas to the piston can be minimized, and this contributes to the reduction in the heat loss. Also, since the volume of the gap created between the outer circumferential surface of the top land and the cylinder wall surface is minimized, the amount of gas that is trapped in this part can be reduced so that the gas flow (which may be referred to as squish) directed from the outer peripheral part of the upper surface (crown surface) of the piston toward the center of the combustion chamber during an upward stroke of the piston can be intensified.

In such an arrangement, preferably, an outer periphery of the crown portion is formed with a first compression ring groove (11), a second compression ring groove (12), and an oil ring groove (13), each extending circumferentially in an annular fashion, in that order from a side of the combustion chamber, and the iron-base portion forms a part defining the first compression ring groove while the aluminum-base portion forms a part defining the second compression ring groove and the oil ring groove, the iron-aluminum boundary portion extending circumferentially in a part located between the first compression ring groove and the oil ring groove.

Thereby, the wear resistance of the part defining the first compression ring groove can be improved.

In such an arrangement, preferably, the aluminum-base portion forms an entire region of the pin boss portions.

Thereby, the weight of the piston can be minimized.

Further, in such an arrangement, preferably, the iron-base portion forms an entire region of the pin boss portions.

Thereby, since the stiffness of the pin boss portions is improved, the diameter of the piston pin and the diameter of the pin hole for receiving the piston pin can be reduced. By reducing the diameter of the pin hole, it becomes possible to reduce the compression height of the piston. When the compression height is reduced, it is then possible to reduce the weight of the piston. In addition, the side force of the piston is reduced so that the frictional force produced between the skirt portion and the cylinder inner wall is reduced.

Further, in such an arrangement, it may be arranged such that the iron-base portion constitutes a part of the pin boss portions on a side of the crown portion, and the aluminum-base portion constitutes a portion of the pin boss portions on a side remote from the crown portion. Further, in this arrangement, the pin boss portions each may be provided with a pin hole (16) into which the piston pin is inserted, and the iron-base portion may constitute a pin hole edge portion (3A) defining the pin hole and a part of each pin boss portion on a side of the crown portion, while the aluminum-base portion may constitute a part of each pin boss portion remote from the side of the crown portion excluding the pin hole edge portion. Further, in this arrangement, the pin boss portions each may be provided with a pin hole (16) into which the piston pin is inserted, and the iron-base portion may constitute a pin hole edge portion (3A) defining the pin hole, while the aluminum-base portion may constitute a remaining part of each pin boss portion excluding the pin hole edge portion. Also, the pin boss portions each may be provided with a pin hole (16) into which the piston pin is inserted, and the iron-base portion may constitute a pin hole edge portion (3A) defining the pin hole and a connecting portion extending from the pin hole edge portion to the crown portion in each pin boss portion, while the aluminum-base portion may constitute a remaining part of each pin boss portion excluding the pin hole edge portion and the connecting portion.

In any of such arrangements, since the stiffness of the part of the pin boss portions surrounding the pin hole is increased, the diameter of the pin hole can be reduced, and the compression height can be reduced. The aluminum-base portion is used in the part that does not substantially affect the stiffness of the pin boss portions so that the weight of the piston can be minimized.

Further, in such an arrangement, the iron-base portion may constitute an outer periphery of the crown portion, while the aluminum-base portion constitutes a central part of the crown portion, the pin boss portions, and the skirt portions.

Thereby, the wear resistance is improved by forming the part requiring a high wear resistance with the iron-base material, and the weight of the piston can be reduced by forming the remaining part with the aluminum-base material.

Further, in such an arrangement, preferably, a cooling channel (14) extending in a circumferential direction is formed in an outer peripheral part of the crown portion, and the aluminum-base portion forms a part of a channel edge portion (2E) defining the cooling channel on a side remote from the combustion chamber.

Since the part of the crown portion requiring a relatively low stiffness is formed by the aluminum-base portion, the weight of the piston can be reduced. In addition, since the oil injected from an oil jet toward the rear surface of the piston is likely to come into contact with the aluminum-base portion, heat conduction from the piston to the oil is promoted so that the cooling of the piston is promoted.

In such an arrangement, the piston may further comprise a resin portion (25) containing a resin material, and an iron-resin boundary portion (26) containing both the iron-base material and the resin material and provided between the iron-base portion and the resin portion by a prescribed thickness to join the iron-base portion and the resin portion to each other, wherein an outer peripheral part of the crown portion is formed with a cooling channel extending in a circumferential direction, the resin portion forming a channel edge portion defining the cooling channel, the iron-base portion forming a remaining part of the outer peripheral part of the crown portion excluding the channel edge portion.

Thereby, a part of the crown portion not requiring a relatively high stiffness is formed by the resin material so that the weight of the piston can be minimized.

In such an arrangement, the piston may further comprise a resin portion (25) containing a resin material, and an aluminum-resin boundary portion (27) containing both the aluminum-base material and the resin material and provided between the aluminum-base portion and the resin portion by a prescribed thickness to join the aluminum-base portion and the resin portion to each other, the aluminum-base portion forming an outer peripheral part of the skirt portions, the resin portion forming an inner peripheral part of the skirt portions.

Thereby, since the part of the skirt portions not requiring a relatively high stiffness is formed by the resin portion so that the weight of the piston can be minimized.

Another aspect of the present invention provides a method for manufacturing a piston including a first portion (20, 21) containing a first material, a second portion (21, 25) containing a second material different from the first material, and a boundary portion (22, 26, 27) containing both the first material and the second material and provided between the first portion and the second portion by a prescribed thickness to join the first portion and the second portion to each other, a composition ratio of the first material progressively decreasing and a composition ratio of the second material progressively increasing in the boundary portion from a side of the first portion to the second portion, the method comprising depositing layers containing the first material and the second material in different composition ratios and in molten state one after another with a progressively varying composition ratio of the first material and the second material.

Thereby, the manufacture of the piston having the boundary portion is simplified.

In such an arrangement, it may be arranged such that the first portion is formed as a single piece member by melt shaping or machining, the boundary portion is formed on a surface of the first portion, and the second portion is formed on a surface of the boundary portion as layers formed by melting the second material. Alternatively, it may be arranged such that the first portion is formed as a single piece member by melt shaping or machining, the boundary portion is formed on a surface of the first portion, and the second portion is formed as a single piece member by melt shaping or machining and attached to the boundary portion. Furthermore, it may also be arranged such that the first portion is formed as a single piece member by melt shaping or machining, the second portion is formed as a single piece member by melt shaping or machining, and the boundary portion is formed as a single piece member and then attached to both the first portion and the second portion.

Thereby, the part that is required to be formed by layered shaping or additive layering is so limited that the manufacturing time is minimized.

### Effect of Invention

Owing to such an arrangement, a piston can be formed by combining different materials without suffering from the problem of interfacial fracture in parts joining the different materials. The present invention also provides a method for manufacturing such a piston.

### BRIEF DESCRIPTION OF THE DRAWING(S)

FIG. 1 is a sectional view of a piston according to a first embodiment of the present invention;

FIG. 2 is a graph showing an exemplary composition ratio in an iron-base portion, an iron-aluminum boundary portion, and an aluminum-base portion;

FIG. 3 is a graph showing another exemplary composition ratio in an iron-base portion, an iron-aluminum boundary portion, and an aluminum-base portion;

FIG. 4 is a sectional view of a piston according to a second embodiment of the present invention;

FIG. 5 is a sectional view of a piston according to a third embodiment of the present invention;

FIG. 6 is a sectional view of a piston according to a fourth embodiment of the present invention;

FIG. 7 is a sectional view of a piston according to a fifth embodiment of the present invention;

FIG. 8 is a sectional view of a piston according to a sixth embodiment of the present invention;

FIG. 9 is a sectional view of a piston according to a seventh embodiment of the present invention;

FIG. 10 is a sectional view of a piston according to an eighth embodiment of the present invention;

FIG. 11 is a sectional view of a piston according to a ninth embodiment of the present invention;

FIG. 12 is a sectional view of a piston according to a tenth embodiment of the present invention; and

FIG. 13 is a schematic diagram of a 3D printer.

### DESCRIPTION OF EMBODIMENTS

A piston according to the present invention is described in the following in terms of specific embodiments with reference to the appended drawings.

### First Embodiment

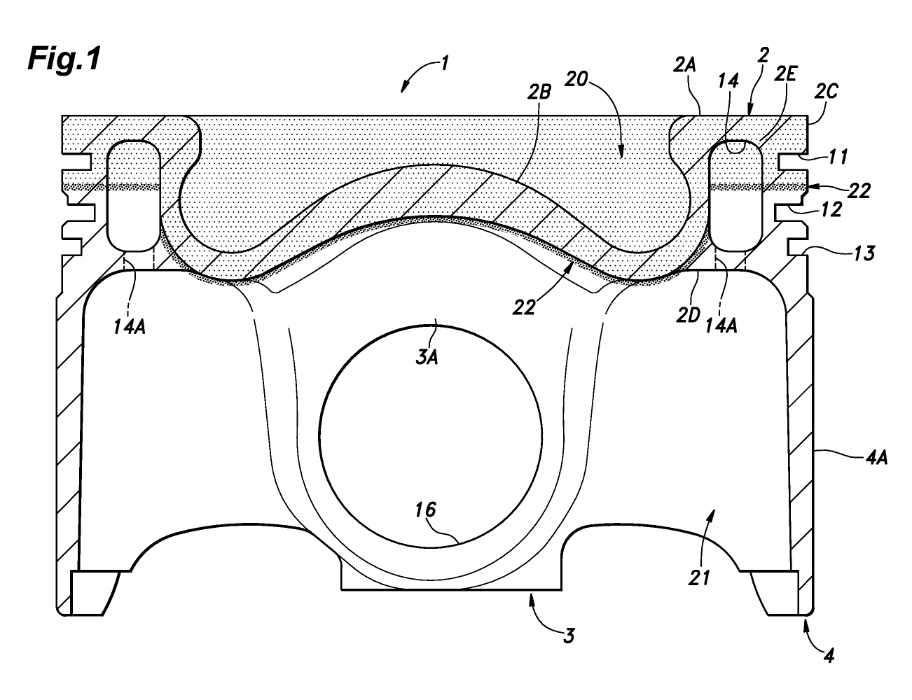

As shown in FIG. 1, a piston 1 of an internal combustion engine according to a first embodiment includes a crown portion 2 (a top land portion) that defines a lower end of a combustion chamber, a pair of pin boss portions 3 projecting downward from a lower surface 2D of the crown portion 2 and configured to receive a piston pin, and a pair of skirt portions 4 projecting downward from an outer peripheral edge of the lower surface 2D of the crown portion 2 and each connected to the respective pin boss portions 3 on either side thereof.

The crown portion 2 is formed in the shape of a disk and the upper surface 2A thereof cooperates with the wall of the cylinder of the internal combustion engine to define the combustion chamber. More specifically, the upper surface 2A of the crown portion 2 defines the lower end of the combustion chamber. A central part of the upper surface 2A of the crown portion 2 is recessed downward so as to define a cavity 2B. On an outer circumferential surface 2C of the crown portion 2, a first compression ring groove 11, a second compression ring groove 12, and an oil ring groove 13 are formed, in that order from above (a combustion chamber side) as annular grooves by being recessed radially inward and extending circumferentially. A first compression ring is fitted in the first compression ring groove 11, a second compression ring is fitted in the second compression ring groove 12, and an oil ring is fitted in the oil ring groove 13.

An outer peripheral part of the crown portion 2 is formed with a cooling channel 14 consisting of an annular passage extending circumferentially around the central axial line of the piston 1. The cooling channel 14 is disposed radially outward of the cavity 2B and radially inward of the first compression ring groove 11, the second compression ring groove 12, and the oil ring groove 13. A plurality of passages 14A extend downward from a lower end of the cooling channel 14 in the crown portion 2, and open to a lower surface 2D of the crown portion 2.

The two pin boss portions 3 protrude downward from the lower surface 2D of the crown portion 2. The two pin boss portions 3 opposed each other in a spaced apart relationship. The pin boss portions 3 are formed with respective through holes 16 that are aligned with each other in a coaxial relationship. Each pin boss portion 3 is provided with a pin hole edge portion 3A that protrudes in a cylindrical shape in the axial direction of the pin hole 16, and defines the pin hole 16. In other words, the pin hole edge portions 3A are each provided with a greater thickness than the remaining part of the pin boss portions 3. A piston pin is inserted in the pin hole 16, and rotatably supports the small end of a connecting rod.

The two skirt portions 4 project downward from the outer peripheral edge of the lower surface 2D of the crown portion 2, and extend laterally or in the circumferential direction along the outer peripheral edge of the crown portion 2 in such a manner that the two lateral edges of each skirt portion 4 are connected to the respective pin boss portions 3. The outer surface 4A of the circumferentially intermediate part of each skirt portion 4 is formed as a cylindrical surface centered around the axis of the piston 1.

The piston 1 includes an iron-base portion 20 (indicated by a dotted region in FIG. 1 and in other drawings) containing an iron-base material, an aluminum-base portion 21 (indicated by a white region in FIG. 1 and in other drawings) containing an aluminum-base material, and an iron-aluminum boundary portion 22 (a darker dotted region in FIG. 1 and in other drawings) containing both the iron-base material and the aluminum-base material and provided between the iron-base portion 20 and the aluminum-base portion 21 to join the iron-base portion 20 to the aluminum-base portion 21. The iron-base material is a material containing iron as a main component and may be an iron alloy such as steel and cast iron. The aluminum-base material is a material containing aluminum as a main component, and may be an aluminum alloy containing at least one of copper, silicon, magnesium, and nickel in addition to aluminum. The aluminum-base material may be, for example, an aluminum-silicon alloy such as Lo-Ex. In this manner, the piston 1 is provided with a plurality of portions made of different materials.

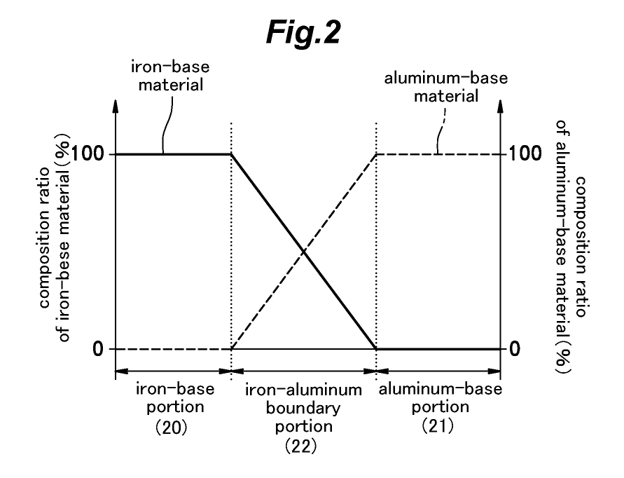

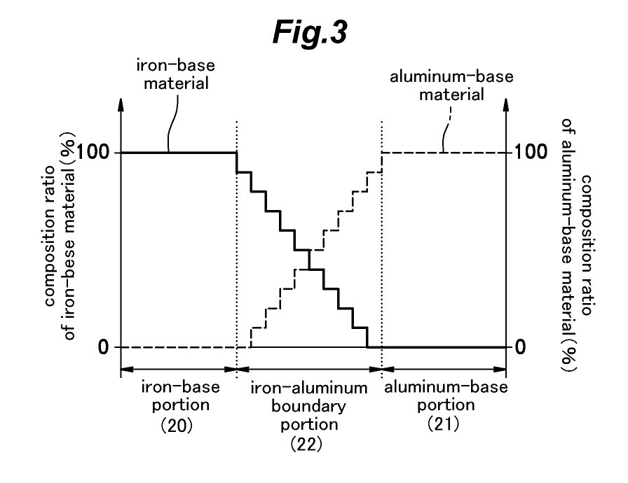

In the iron-aluminum boundary portion 22, the composition ratio of the iron-base material progressively decreases and the composition ratio of the aluminum-base material progressively increases from the side of the iron-base portion 20 to the side of the aluminum-base portion 21. As shown in FIG. 2, in the iron-aluminum boundary portion 22, the composition ratio of the iron-base material progressively decreases continuously while the composition ratio of the aluminum-base material progressively increases from the side of the iron-base portion 20 to the side of aluminum-base portion 21. In the iron-aluminum boundary portion 22, the composition ratio of the iron-base material may linearly decrease while the composition ratio of the aluminum-base material linearly increases from the side of the iron-base portion 20 to the side of the aluminum-base portion 21. Although not shown in the drawings, in the iron-aluminum boundary portion 22, the composition ratio of the iron-base material may also progressively decreases in a curved fashion while the composition ratio of the aluminum-base material progressively increases in a curved fashion from the side of the iron-base portion 20 to the side of the aluminum-base portion 21. Further, as shown in FIG. 3, in the iron-aluminum boundary portion 22, the composition ratio of the iron-base material may also progressively decreases in a stepwise fashion while the composition ratio of the aluminum-base material progressively increases in a stepwise fashion from the side of the iron-base portion 20 to the side of the aluminum-base portion 21. The thickness of the iron-aluminum boundary portion 22 may be, not exclusively, equal to or greater than 0.5 mm and equal to or less than 30 mm, for example.

In the first embodiment, the iron-base portion 20 constitutes a central part of the crown portion 2 and an outer peripheral pat of the crown portion 2 on the side of the combustion chamber (the upper half of the outer peripheral part), and the aluminum-base portion 21 constitutes an outer peripheral part of the crown portion 2 remote from the side of the combustion chamber (the lower half of the outer peripheral part), the entire region of the pin boss portions 3, and the entire region of the skirt portions 4. The iron-aluminum boundary portion 22 is provided in an outer peripheral part of the crown portion 2 defining a boundary between the iron-base portion 20 and the aluminum-base portion 21. The iron-base portion 20 constitutes a part defining the first compression ring groove 11 in the outer peripheral part of the crown portion 2, and the aluminum-base portion 21 constitutes a part defining the second compression ring groove 12 and the oil ring groove 13 in the outer peripheral part of the crown portion 2. In other words, in the present embodiment, the iron-base portion 20 is provided in the part of the piston 1 on the side of the combustion chamber with respect to the axial direction of the piston 1, and the aluminum-base portion 21 is provided in the part of the piston 1 on the side remote from the combustion chamber with respect to the axial direction of the piston 1.

The iron-aluminum boundary portion 22 extends from the outer circumferential surface 2C of the crown portion 2, via a part located between the first compression ring groove 11 and the second compression ring groove 12, to the outer periphery of the cooling channel 14, and extends from the lower end of the cooling channel 14 to the lower surface 2D of the crown portion 2. The iron-aluminum boundary portion 22 also extends along the boundary between the crown portion 2 and the pin boss portions 3.

In the second to tenth embodiments described in the following, the parts of the piston 1 that are formed by the iron-base portion 20 and the aluminum-base portion 21 differ from those of the piston 1 of the first embodiment. In the following description of the various embodiments, parts corresponding to those of the first embodiment are denoted with like numerals, and such parts may be omitted from the description.

### Second Embodiment

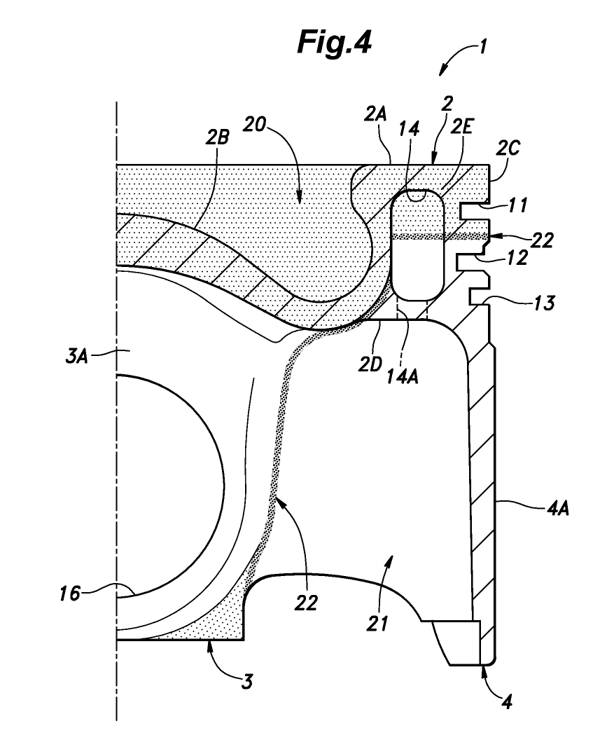

As shown in FIG. 4, in the second embodiment, the iron-base portion 20 constitutes a central part of the crown portion 2 and an outer peripheral part of the crown portion 2 on the side of the combustion chamber, and the entire region of the pin boss portions 3, while the aluminum-base portion 21 constitutes an outer peripheral part of the crown portion 2 remote from the combustion chamber, and the entire region of the skirt portions 4. The iron-base portion 20 constitutes an outer peripheral part of the crown portion 2 defining the first compression ring groove 11, and the aluminum-base portion 21 constitutes an outer peripheral part of the crown portion 2 defining the second compression ring groove 12 and the oil ring groove 13.

The iron-aluminum boundary portion 22 is provided at the boundary between the iron-base portion 20 and the aluminum-base portion 21, and extends from the outer circumferential surface 2C of the crown portion 2, via a part located between the first compression ring groove 11 and the second compression ring groove 12, to an outer periphery of the cooling channel 14, and via the lower end of the cooling channel 14 to the lower surface 2D of the crown portion 2. Further, the iron-aluminum boundary portion 22 extends along the boundary between the skirt portions 4 and the pin boss portions 3.

### Third Embodiment

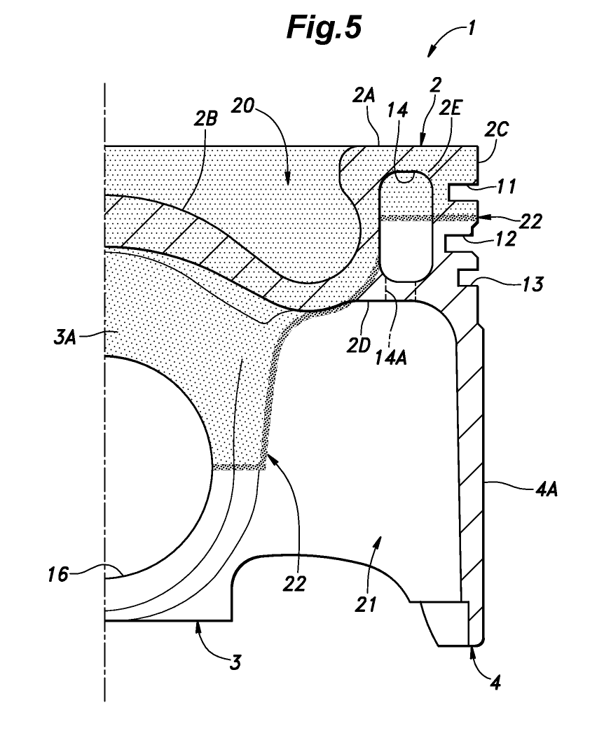

As shown in FIG. 5, in the third embodiment, the iron-base portion 20 constitutes a central part of the crown portion 2, an outer peripheral part of the crown portion 2 on the side of the combustion chamber, and parts of the pin boss portions on the side of the combustion chamber (upper half of the pin boss portions 3), while the aluminum-base portion 21 constitutes an outer peripheral part of the crown portion 2 remote from the side of the combustion chamber, the entire region of the skirt portions 4, and parts of the pin boss portions 3 remote from the side of the combustion chamber (lower half of the pin boss portions 3). The iron-base portion 20 constitutes an outer peripheral part of the crown portion 2 defining the first compression ring groove 11, and the aluminum-base portion 21 constitutes an outer peripheral part of the crown portion 2 defining the second compression ring groove 12 and the oil ring groove 13.

The iron-aluminum boundary portion 22 is provided at the boundary between the iron-base portion 20 and the aluminum-base portion 21, and extends from the outer circumferential surface 2C of the crown portion 2, via a part located between the first compression ring groove 11 and the second compression ring groove 12, to an outer periphery of the cooling channel 14, and extends from a lower end of the cooling channel 14 to the lower surface 2D of the crown portion 2. The iron-aluminum boundary portion 22 extends along the boundary between the upper half of the skirt portions 4 and the upper half of the pin boss portions 3, and then extends toward the pin holes 16 along the imaginary lines dividing the respective pin boss portions 3 each upper and lower parts.

### Fourth Embodiment

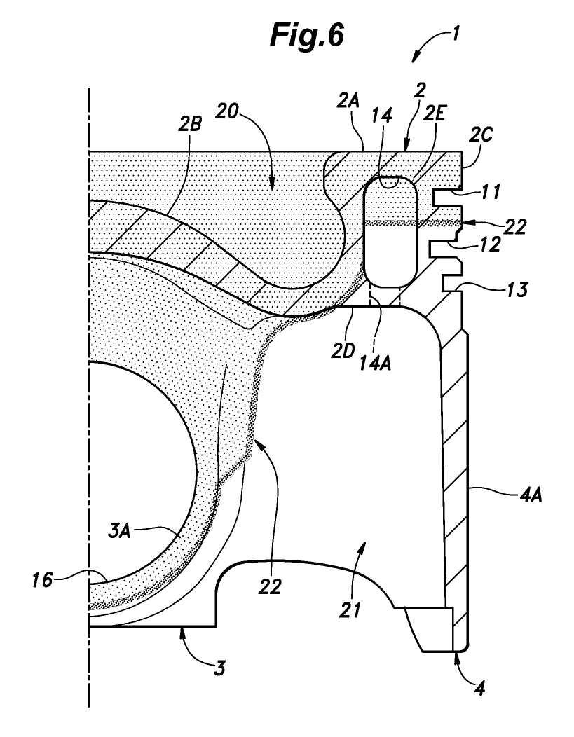

As shown in FIG. 6, in the fourth embodiment, the iron-base portion 20 constitutes a central part of the crown portion 2, an outer peripheral part of the crown portion 2 on the side of the combustion chamber, parts of the pin boss portions on the side of the combustion chamber, and the pin hole edge portions 3A, while the aluminum-base portion 21 constitutes an outer peripheral part of the crown portion 2 remote from the side of the combustion chamber, the entire region of the skirt portions 4, and parts of the pin boss portions 3 remote from the side of the combustion chamber excluding the pin hole edge portions 3A. The iron-base portion 20 constitutes an outer peripheral part of the crown portion 2 defining the first compression ring groove 11, and the aluminum-base portion 21 constitutes an outer peripheral part of the crown portion 2 defining the second compression ring groove 12 and the oil ring groove 13.

The iron-aluminum boundary portion 22 is provided at the boundary between the iron-base portion 20 and the aluminum-base portion 21, and extends from the outer circumferential surface 2C of the crown portion 2, via a part located between the first compression ring groove 11 and the second compression ring groove 12, to an outer periphery of the cooling channel 14, and extends from a lower end of the cooling channel 14 to the lower surface 2D of the crown portion 2. The iron-aluminum boundary portion 22 extends along the boundary between the upper half of the skirt portions 4 and the upper half of the pin boss portions 3, and extends along the lower half of the pin hole edge portion 3A of each pin boss portion 3.

### Fifth Embodiment

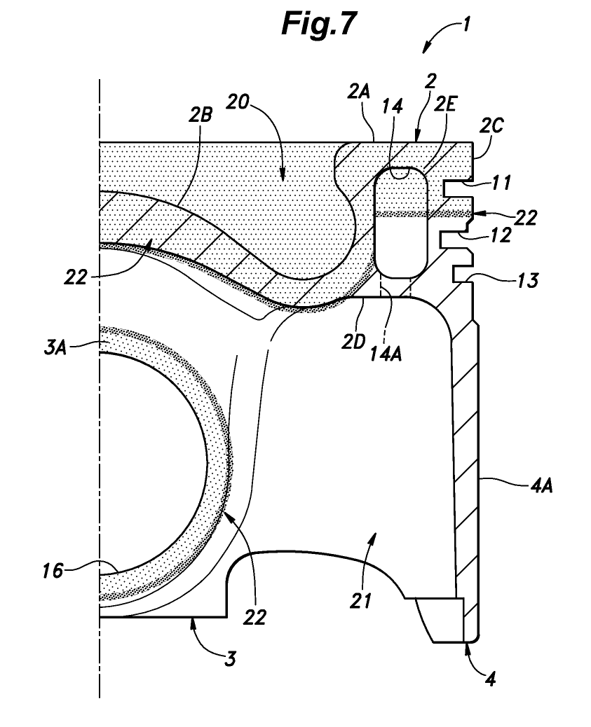

As shown in FIG. 7, in the fifth embodiment, the iron-base portion 20 constitutes a central part of the crown portion 2, an outer peripheral part of the crown portion 2 on the side of the combustion chamber, and the pin hole edge portions 3A, while the aluminum-base portion 21 constitutes an outer peripheral part of the crown portion 2 remote from the side of the combustion chamber, the entire region of the skirt portions 4, and the pin boss portions 3 excluding the pin hole edge portions 3A. The iron-base portion 20 constitutes an outer peripheral part of the crown portion 2 defining the first compression ring groove 11, and the aluminum-base portion 21 constitutes an outer peripheral part of the crown portion 2 defining the second compression ring groove 12 and the oil ring groove 13.

The iron-aluminum boundary portion 22 is provided at the boundary between the iron-base portion 20 and the aluminum-base portion 21, and extends from the outer circumferential surface 2C of the crown portion 2, via a part located between the first compression ring groove 11 and the second compression ring groove 12, to an outer periphery of the cooling channel 14, and extends from a lower end of the cooling channel 14 to the lower surface 2D of the crown portion 2. The iron-aluminum boundary portion 22 extends along the pin hole edge portion 3A of each pin boss portion 3.

### Sixth Embodiment

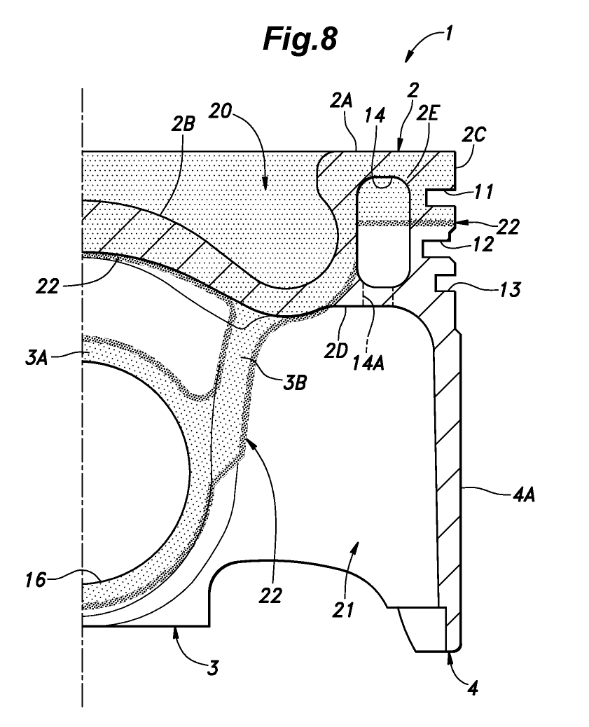

As shown in FIG. 8, in the sixth embodiment, the iron-base portion 20 constitutes a central part of the crown portion 2, an outer peripheral part of the crown portion 2 on the side of the combustion chamber, the pin hole edge portions 3A, and connecting portions 3B each extending from a corresponding pin hole edge portion 3A to the crown portion 2, while the aluminum-base portion 21 constitutes an outer peripheral part of the crown portion 2 remote from the side of the combustion chamber, the entire region of the skirt portions 4, and the pin boss portions 3 excluding the pin hole edge portions 3A and the connecting portions 3B. The iron-base portion 20 constitutes an outer peripheral part of the crown portion 2 defining the first compression ring groove 11, and the aluminum-base portion 21 constitutes an outer peripheral part of the crown portion 2 defining the second compression ring groove 12 and the oil ring groove 13. The connecting portions 3B extend along the boundaries between the pin boss portions 3 and the skirt portions 4. In an alternate embodiment, the position and the number of the connecting portions 3B may be freely selected. For example, the connecting portion 3B may linearly extend vertically through the center of each pin boss portion 3.

The iron-aluminum boundary portion 22 is provided at the boundary between the iron-base portion 20 and the aluminum-base portion 21, and extends from the outer circumferential surface 2C of the crown portion 2, via a part located between the first compression ring groove 11 and the second compression ring groove 12, to an outer periphery of the cooling channel 14, and extends from a lower end of the cooling channel 14 to the lower surface 2D of the crown portion 2. The iron-aluminum boundary portion 22 extends along the pin hole edge portion 3A of each pin boss portion 3, and along either side edge of each connecting portion 3B.

### Seventh Embodiment

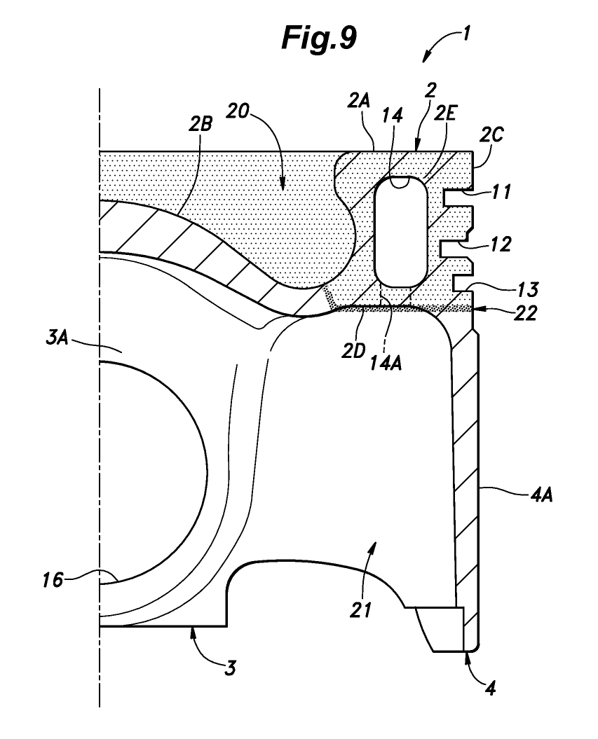

As shown in FIG. 9, in the seventh embodiment, the iron-base portion 20 constitutes an outer peripheral part of the crown portion 2, while the aluminum-base portion 21 constitutes a central part of the crown portion 2, the entire region of the skirt portions 4 and the entire region of the pin boss portions 3. The iron-base portion 20 is provided on a radially outer part of the piston 1, and the aluminum-base portion 21 is provided a radially inward of the iron-base portion 20.

The iron-aluminum boundary portion 22 is provided at the boundary between the iron-base portion 20 and the aluminum-base portion 21, and extends from the upper surface 2A to the lower surface 2D of the crown portion 2, and extends annularly around the central axis of the piston 1. The iron-aluminum boundary portion 22 also extends along the boundary between the crown portion 2 and the skirt portions 4.

### Eighth Embodiment

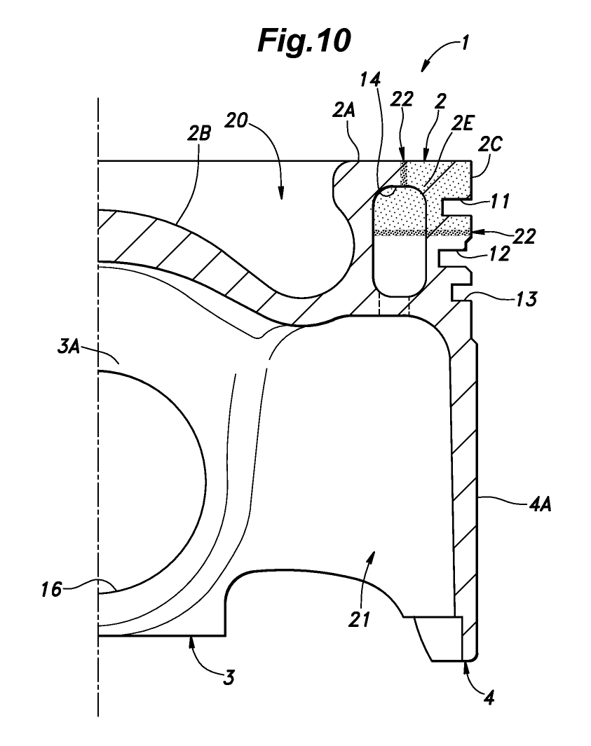

As shown in FIG. 10, in the eighth embodiment, the iron-base portion 20 constitutes an outer peripheral part of the crown portion 2 on the side of the combustion chamber, while the aluminum-base portion 21 constitutes an outer peripheral part of the crown portion 2 remote from the side of the combustion chamber, a central part of the crown portion 2, the entire region of the skirt portions 4, and the entire region of the pin boss portions 3. The iron-base portion 20 constitutes an outer peripheral part of the crown portion 2 defining the first compression ring groove 11, and the aluminum-base portion 21 constitutes an outer peripheral part of the crown portion 2 defining the second compression ring groove 12 and the oil ring groove 13.

The iron-aluminum boundary portion 22 is provided at the boundary between the iron-base portion 20 and the aluminum-base portion 21, and extends from the outer circumferential surface 2C of the crown portion 2, via a part located between the compression ring groove 11 and the second compression ring groove 12, to the outer periphery of the cooling channel 14, and extends from an upper end of the cooling channel 14 to the upper surface 2A of the crown portion 2.

### Ninth Embodiment

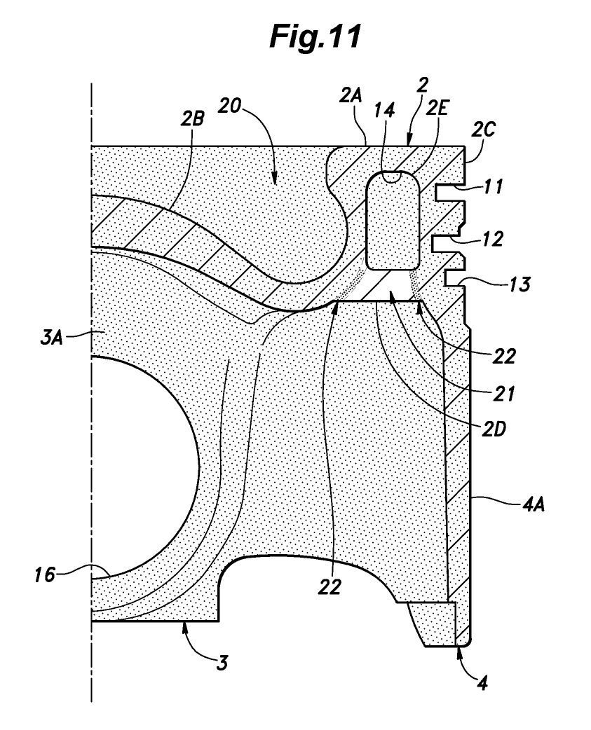

As shown in FIG. 11, in the ninth embodiment, the iron-base portion 20 constitutes a central part of the crown portion 2, an outer peripheral part of the crown portion 2 excluding a part defining the lower end of the cooling channel 14, the entire region of the skirt portions 4, and the entire region of the pin boss portion 3, while the aluminum-base portion 21 constitutes a part of the crown portion 2 defining the lower end of the cooling channel 14.

The iron-aluminum boundary portion 22 is provided at the boundary between the iron-base portion 20 and the aluminum-base portion 21, and extends along either side surface of the aluminum-base portion 21 in a lower part of an outer peripheral part of the crown portion 2 from the wall surface defining a lower end of the cooling channel 14 to the lower surface 2D of the crown portion 2.

### Tenth Embodiment

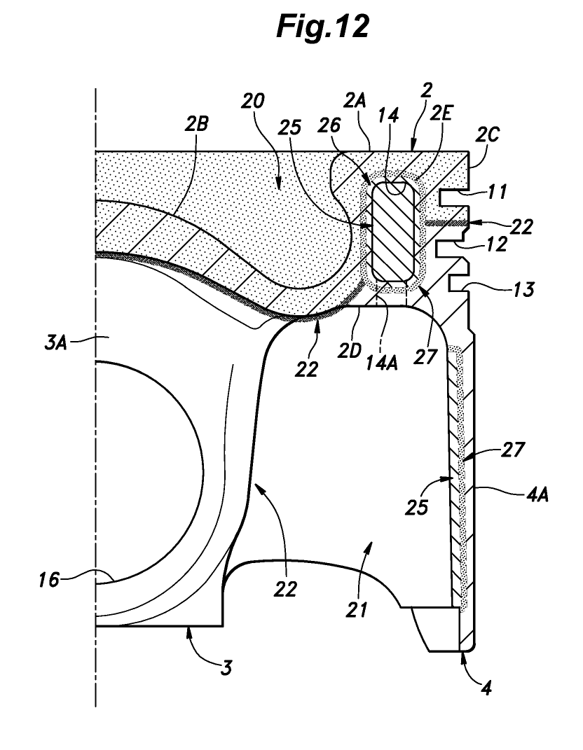

As shown in FIG. 12, the piston 1 of the tenth embodiment includes, in addition to the iron-base portion 20 and the aluminum-base portion 21, a resin portion 25 containing a resin material, an iron-resin boundary portion 26 containing both the iron-base material and the resin material and provided between the iron-base portion 20 and the resin portion 25 by a prescribed thickness to join the iron-base portion 20 and the resin portion 25 to each other, and an aluminum-resin boundary portion 27 containing both the aluminum-base material and the resin material and provided between the aluminum-base portion 21 and the resin portion 25 by a prescribed thickness to join the aluminum-base portion 21 and the resin portion 25 to each other. The resin material may consist of a heat resistant resin material such as a polyimide resin, a polyamide imide resin, an epoxy resin, a nylon-6 resin, a nylon-6, 6 resin, or the like, for example.

The iron-resin boundary portion 26 is provided between the iron-base portion 20 and the resin portion 25 by a prescribed thickness, and the composition ratio of the iron-base material progressively decreases and the composition ratio of the resin material progressively increases from the side of the iron-base portion 20 to the side of the resin portion 25. The change or the gradient in the composition ratio of the iron-base material and the resin material in the iron-resin boundary portion 26 may be either continuous or stepwise. The change or the gradient in the composition ratio of the aluminum-base material and the resin material in the aluminum-resin boundary portion 27 may be either continuous or stepwise. The thicknesses of the iron-resin boundary portion 26 and the aluminum-resin boundary portion 27 may be, not exclusively, equal to or greater than 0.5 mm and equal to or less than 30 mm.

The iron-base portion 20 constitutes a central part of the crown portion 2, and an outer peripheral part of the crown portion 2 on the side of the combustion chamber excluding a channel edge portion 2E defining the cooling channel 14. The aluminum-base portion 21 constitutes an outer peripheral part of the crown portion 2 remote from the side of the combustion chamber excluding the channel edge portion 2E, the entire region of the pin boss portions 3, and an outer peripheral part of the skirt portions 4. The resin portion 25 constitutes the channel edge portion 2E and an inner peripheral part of the skirt portions 4. The iron-base portion 20 constitutes an outer peripheral part of the crown portion 2 defining the first compression ring groove 11, and the aluminum-base portion 21 constitutes an outer peripheral part of the crown portion 2 defining the second compression ring groove 12 and the oil ring groove 13. The channel edge portion 2E is a region extending from the wall surface of the cooling channel 14 radially outward with respect to the center of the cooling channel 14 by a prescribed width, and is provided with a tubular shape.

The iron-resin boundary portion 26 is provided at the boundary between the iron-base portion 20 and the resin portion 25, and extends along an upper part of the outer peripheral edge of the channel edge portion 2E. The aluminum-resin boundary portion 27 is provided at the boundary between the aluminum-base portion 21 and the resin portion 25, and extends along a lower part of the outer peripheral edge of the channel edge portion 2E. Further, the aluminum-resin boundary portion 27 extends vertically in the skirt portions 4 so as to separate the skirt portions 4 into two parts in the thickness direction.

### (Piston Manufacturing Method)

The pistons 1 of the first to tenth embodiments can be manufactured by the following manufacturing method. The iron-aluminum boundary portion 22, the iron-resin boundary portion 26, and the aluminum-resin boundary portion 27 are formed by using a known layered additive manufacturing method. Since the workpiece is formed by laminating the layers, the composition of the material can be changed in the laminating direction by changing the composition of each layer in performing the additive manufacturing method. The additive manufacturing method may be a powder lamination method such as selective laser melting (SLM) method and a selective laser sintering (SLS), for example.

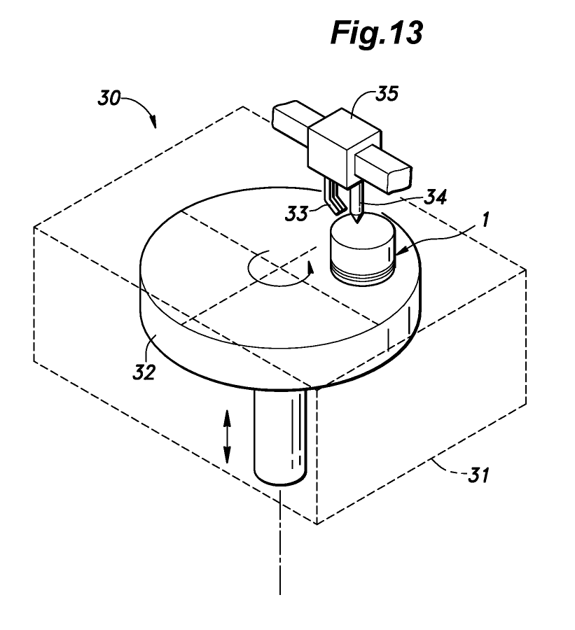

As an example, a piston 1 is manufacture by using a selective laser melting method. FIG. 13 shows an example of a 3D printer 30 that is configured to manufacture a workpiece by using a layered modeling method. As shown in FIG. 13, the 3D printer 30 includes a case 31 having an open upper end, a table 32 that supports the case 31 having the workpiece placed therein, nozzles 33 configure to supply powder material, and a laser device 34 for irradiating laser light to the supplied powder material to melt the same. The table 32 is moveable in the vertical direction and rotatable around a prescribed axial line. The table 32 has a plurality of work areas arranged in the circumferential direction, and the current work area can be changed by rotating the table 32. The workpiece can be worked in each work area. In addition, the table 32 moves downward as each layer of the workpiece is formed so that the position where the material is layered can be maintained at a constant height.

The nozzles 33 include a first nozzle for supplying an iron-base material in powder form, a second nozzle for supplying an aluminum-base material in powder form, and a third nozzle for supplying a resin material in powder form. Each of the first to third nozzles is provided with a throttle valve so that the amount of material to be supplied can be adjusted. By changing the amount of the material supplied from each of the first to third nozzles, the composition ratio of the material supplied to each particular position of the workpiece can be changed. The nozzles 33 and the laser device 34 are supported by a drive device 35 including, for example, a guide rail and a motor so as to be moveable forward and backward and right and left with respect to the table 32.

The 3D printer 30 controls the nozzles 33 based on three-dimensional data on the shapes of the iron-aluminum boundary portion 22, the iron-resin boundary portion 26 and the aluminum-resin boundary portion 27, and the composition ratio of the material of each portion in such a manner that material having a specific composition ratio is supplied to each particular position of the workpiece, and laminating each material layer by selectively irradiating a laser beam to each particular position of the workpiece, and melting the corresponding part of the material.

It is also possible to form the iron-base portion 20, the aluminum-base portion 21, and the resin portion 25 each as a single piece by melt shaping or machining, or by the layered additive manufacturing method described above. Melt shaping as used herein includes casting and injection molding, and machining as used herein includes cutting and forging.

In a first example of a manufacturing method of the piston 1 including the iron-base portion 20, the aluminum-base portion 21, and the iron-aluminum boundary portion 22, first of all, one of the iron-base portion 20 and the aluminum-base portion 21 is formed by melt shaping or machining as a single piece member. Then, an iron-aluminum boundary portion 22 and the other of the iron-base portion 20 and the aluminum-base portion 21 are formed on a surface of the one of the iron-base portion 20 and the aluminum-base portion 21 by a layered additive manufacturing method.

In a second example of a manufacturing method of the piston 1 including the iron-base portion 20, the aluminum-base portion 21, and the iron-aluminum boundary portion 22, first of all, one of the iron-base portion 20 and the aluminum-base portion 21 is formed by melt shaping or machining as a single piece member. Then, an iron-aluminum boundary portion 22 is formed on a surface of the one of the iron-base portion 20 and the aluminum-base portion 21 by a layered additive manufacturing method. The other of the iron-base portion 20 and the aluminum-base portion 21 is formed by melt shaping or machining as a single piece member, and is joined to the iron-aluminum boundary portion 22 by a per se known bonding method such as welding, friction stir welding and forging.

In a third example of a manufacturing method of the piston 1 including the iron-base portion 20, the aluminum-base portion 21, and the iron-aluminum boundary portion 22, first of all, the iron-base portion 20 and the aluminum-base portion 21 are formed by melt shaping or machining each as a single piece member. Then, an iron-aluminum boundary portion 22 is formed by a layered additive manufacturing method. Next, the iron-aluminum boundary portion 22 is bonded to the iron-base portion 20 and the aluminum-base portion 21 by a per se known joining method such as welding, friction stir welding and forging.

In a fourth example of a manufacturing method of the piston 1 including the iron-base portion 20, the aluminum-base portion 21, and the iron-aluminum boundary portion 22, the iron-base portion 20, the aluminum-base portion 21 and the iron-aluminum boundary portion 22 are formed as a single piece by a layered additive manufacturing method.

In an example of a manufacturing method for the piston 1 including the iron-base portion 20, the aluminum-base portion 21, the resin portion 25, the iron-aluminum boundary portion 22, the iron-resin boundary portion 26, and the aluminum-resin boundary portion 27, the iron-base portion 20, the aluminum-base portion 21, the resin portion 25, the iron-aluminum boundary portion 22, the iron-resin boundary portion 26, and the aluminum-resin boundary portion 27 are integrally formed by a layered additive manufacturing method. In an alternate embodiment, a part of the iron-base portion 20, the aluminum-base portion 21, the resin portion 25 are each formed as a single piece member in advance, and the remaining components are formed on the surfaces of the single piece members by a layered additive manufacturing method.

The effects of the pistons 1 of the foregoing embodiments are discussed in the following. Since the iron-aluminum boundary portion 22 is provided between the iron-base portion 20 and the aluminum-base portion 21, and the composition ratios of the iron-base material and the aluminum-base material progressively change in the iron-aluminum boundary portion 22, stress caused by the difference between the thermal coefficients of the iron-base material and the aluminum-base material can be minimized. As a result, the iron-aluminum boundary portion 22 is protected from damages. Similarly for the iron-resin boundary portion 26 provided between the iron-base portion 20 and the resin portion 25, and the aluminum-resin boundary portion 27 provided between the aluminum-base portion 21 and the resin portion 25, by avoiding the composition ratio of the materials from changing sharply in the boundary so that damage that could be caused by the difference between the thermal expansion coefficients of the two materials can be minimized.

When the crown portion 2 is constituted by the iron-base portion 20, the heat resistance and the stiffness of the crown portion 2 are improved as compared with the case where the crown portion 2 is constituted by the aluminum-base portion 21. Further, since the heat storage property of the crown portion 2 is improved, the cooling loss is reduced.

When the part of the crown portion 2 defining the first compression ring groove 11 is constituted by the iron-base portion 20, the wear resistance is improved as compared with the case where the crown portion 2 is constituted by the aluminum-base portion 21 so that the wear due to the first compression ring is minimized. Since the part of the crown portion 2 defining the second compression ring groove 12 and the oil ring groove 13 is not required to be wear resistance and heat resistant as compared with the part defining the first compression ring groove 11, the weight of the piston 1 can be reduced by forming this part with the aluminum-base portion 21.

Since the part of the crown portion 2 defining the first compression ring groove 11 is constituted by the iron-base portion 20, the top land (the part extending from the upper surface 2A of the piston 1 to the first compression ring groove 11) can be reduced in height. As a result, the surface area of the outer circumferential surface of the top land of the piston 1 is reduced, and the surface area of the piston 1 on the side of the combustion chamber is reduced. When this surface area is reduced, the transfer of heat from the combustion gas to the piston 1 is reduced so that the cooling loss is further reduced. In addition, since the volume of the gap created between the outer circumferential surface of the top land and the cylinder wall surface is reduced, the amount of gas staying in this part is reduced so that squish is promoted. This in turn makes the gas flow in the combustion chamber more active, and improves the combustion efficiency.

When the channel edge portion 2E defining the cooling channel 14 in the crown portion 2 is formed by the resin portion 25, the cooling of the crown portion 2 is suppressed so that the cooling loss is reduced. Also, since the part defining the side of the cooling channel 14 remote from the combustion chamber in the crown portion 2 is not required to be so high in stiffness and heat resistance, by constituting this part as the aluminum-base portion 21, the weight of the piston 1 can be reduced. In addition, since the oil injected from the oil jet toward the rear surface of the piston 1 is likely to come into contact with the aluminum-base portion 21, heat conduction from the piston 1 to the oil is promoted so that the cooling of the piston 1 is promoted. In an alternate embodiment, when it is desired to suppress the cooling efficiency, the aluminum-base portion 21 may be replaced with the resin portion 25.

When the skirt portions 4 are constituted by the aluminum-base portion 21, the weight can be reduced as compared with the case where the skirt portions 4 are constituted by the iron-base portion 20. Further, by making the outer peripheral part of the skirt portions 4 with the aluminum-base portion 21 and the inner peripheral part of the skirt portion 4 with the resin portion 25, the weight of the piston 1 can be reduced even further.

When the pin boss portions 3 are constituted by the iron-base portion 20, the stiffness thereof is improved as compared with the case where the pin boss portions 3 are constituted by the aluminum-base portion 21. Therefore, the diameter of the piston pin and the pin hole 16 can be reduced. As a result, the compression height of the piston 1 is reduced, and the weight thereof can be reduced. In addition, as the compression height is reduced, the side force generated in the piston 1 is reduced so that the friction between the skirt portion 4 and the cylinder wall surface can be minimized. The stiffness of the pin boss portions 3 can be improved by forming the pin hole edge portions 3A and the upper part of the pin boss portions 3 with the iron-base portion 20. Also, the weight of the piston 1 can be reduced by forming the lower part of the pin boss portions 3 with the aluminum-base portion 21. When the pin hole edge portions 3A and the crown portion 2 are connected by the iron-base portion 20, the stiffness of the piston 1 can be efficiently improved. Therefore, the pin hole edge portions 3A and the crown portion 2 may be connected to each other by the connecting portions 3B formed by the iron-base portion 20.

The thickness of the iron-aluminum boundary portion 22 is desired to be thick from the viewpoint of decreasing the gradient of the thermal expansion coefficient from the side of the iron-base portion 20 to the side of the aluminum-base portion 21. If the thickness of the iron-aluminum boundary portion 22 is 0.5 mm or more, for example, the gradient of the composition ratio per unit length from the side of the iron-base portion 20 to the side of the aluminum-base portion 21 becomes sufficiently small so that the difference in the thermal expansion between the two portions can be favorably reduced. Thereby, even in a high temperature condition, stress concentration in the iron-aluminum boundary portion 22 can be avoided, and damage in the iron-aluminum boundary portion 22 can be avoided. On the other hand, the thickness of the iron-aluminum boundary portion 22 is desired to be small from the viewpoint of the manufacturing time and the manufacturing cost. When the iron-aluminum boundary portion 22 is to be formed by the above-mentioned layered additive manufacturing method, a greater thickness of the iron-aluminum boundary portion 22 means an increase in both the manufacturing time and the manufacturing cost. Therefore, from the viewpoint of reducing the gradient of the thermal expansion and the manufacturing time and manufacturing cost, the thickness of the iron-aluminum boundary portion 22 is preferably equal to or greater than 0.5 mm and equal to or less than 30 mm.

The present invention has been described in terms of specific embodiments, but is not limited by such embodiments, and can be freely modified without departing from the spirit of the present invention. For instance, in the foregoing embodiments, the piston 1 included at least two of an iron-base portion 20, an aluminum-base portion 21, and a resin portion 25, but it is also possible for the piston 1 to include four or more such portions. In such a case, the boundary portions should be provided so as to correspond to the number of different portions made of different materials. Further, the piston according to the present invention can be applied to various other known internal combustion engines such as gasoline engines, diesel engines, HCCI engines and so on.
1: piston
2: crown portion
2E: channel edge portion
3: pin boss portion
3A: pin hole edge portion
3B: connecting portion
4: skirt portion
11: first compression ring groove
12: second compression ring groove
13: oil ring groove
14: cooling channel
16: pin hole
20: iron-base portion
21: aluminum-base portion
22: iron-aluminum boundary portion
25: resin portion
26: iron-resin boundary portion
27: aluminum-resin boundary portion
30: 3D printer

1. A piston of an internal combustion engine, comprising:
a first portion containing a first material;
a second portion containing a second material different from the first material; and
a boundary portion containing both the first material and the second material and provided between the first portion and the second portion by a prescribed thickness which is equal to or greater than 0.5 mm and equal to or less than 30 mm to join the first portion and the second portion to each other,
wherein a composition ratio of the first material progressively decreases and a composition ratio of the second material progressively increases in the boundary portion from a side of the first portion to a side of the second portion.

2. The piston according to claim 1, wherein the composition ratio of the first material progressively and continuously decreases and the composition ratio of the second material progressively and continuously increases in the boundary portion from the side of the first portion to the side of the second portion.

3. The piston according to claim 2, wherein the composition ratio of the first material progressively and linearly decreases and the composition ratio of the second material progressively and linearly increases in the boundary portion from the side of the first portion to the side of the second portion.

4. The piston according to claim 1, wherein the composition ratio of the first material progressively decreases in a stepwise fashion and the composition ratio of the second material progressively increases in a stepwise fashion in the boundary portion from the side of the first portion to the side of the second portion.

5. The piston according to claim 1, wherein the first material is an iron-base material and the second material is an aluminum-base material.

6. The piston according to claim 1, wherein the first material is an aluminum-base material or an iron-base material, and the second material is a resin material.

7. The piston according to claim 5, wherein the first portion is provided in a part of the piston on a side of a combustion chamber with respect an axial direction thereof, and the second portion is provided in a part of the piston on a side remote from the combustion chamber with respect to the axial direction thereof.

8. The piston according to claim 5, wherein the first portion is provided in a radially outer part of the piston, and the second portion is provided in a radially more inner part of the piston than the first portion.

9. A piston of an internal combustion engine, comprising:
a crown portion defining a lower end of a combustion chamber;
a pair of pin boss portions projecting from the crown portion away from the combustion chamber, and receiving a piston pin; and
a pair of skirt portions projecting from the crown portion away from the combustion chamber, and connected to the corresponding pin boss portions,
wherein the piston includes an iron-base portion containing an iron-base material,
an aluminum-base portion containing an aluminum-base material, and
an iron-aluminum boundary portion containing both the iron-base material and the aluminum-base material and provided between the iron-base portion and the aluminum-base portion by a prescribed thickness to join the iron-base portion and the aluminum-base portion to each other, and
wherein a composition ratio of the iron-base material progressively decreases and a composition ratio of the aluminum-base material progressively increases in the boundary portion from a side of the iron-base portion to a side of the aluminum-base portion, the iron-base portion forming at least a part of the crown portion, the aluminum-base portion forming at least a part of the skirt portions.

10. The piston according to claim 9, wherein the iron-base portion comprises a part of the crown portion defining the combustion chamber.

11. The piston according to claim 10, wherein an outer periphery of the crown portion is formed with a first compression ring groove, a second compression ring groove, and an oil ring groove, each extending circumferentially in an annular fashion, in that order from a side of the combustion chamber, and the iron-base portion forms a part defining the first compression ring groove while the aluminum-base portion forms a part defining the second compression ring groove and the oil ring groove, the iron-aluminum boundary portion extending circumferentially in a part located between the first compression ring groove and the oil ring groove.

12. The piston according to claim 9, wherein the aluminum-base portion forms an entire region of the pin boss portions.

13. The piston according to claim 9, wherein the iron-base portion forms an entire region of the pin boss portions.

14. The piston according to claim 9, wherein the iron-base portion constitutes a part of the pin boss portions on a side of the crown portion, and the aluminum-base portion constitutes a portion of the pin boss portions on a side remote from the crown portion.

15. The piston according to claim 9, wherein the pin boss portions are each provided with a pin hole into which the piston pin is inserted, and wherein the iron-base portion constitutes a pin hole edge portion defining the pin hole and a part of each pin boss portion on a side of the crown portion, while the aluminum-base portion constitutes a part of each pin boss portion remote from the side of the crown portion excluding the pin hole edge portion.

16. The piston according to claim 9, wherein the pin boss portions are each provided with a pin hole into which the piston pin is inserted, and wherein the iron-base portion constitutes a pin hole edge portion defining the pin hole, and the aluminum-base portion constitutes a remaining part of each pin boss portion excluding the pin hole edge portion.

17. The piston according to claim 9, wherein the pin boss portions are each provided with a pin hole into which the piston pin is inserted, and wherein the iron-base portion constitutes a pin hole edge portion defining the pin hole and a connecting portion extending from the pin hole edge portion to the crown portion in each pin boss portion, while the aluminum-base portion constitutes a remaining part of each pin boss portion excluding the pin hole edge portion and the connecting portion.

18. The piston according to claim 9, wherein the iron-base portion constitutes an outer periphery of the crown portion, while the aluminum-base portion constitutes a central part of the crown portion, the pin boss portions, and the skirt portions.

19. The piston according to claim 9, wherein a cooling channel 14 extending in a circumferential direction is formed in an outer peripheral part of the crown portion, and the aluminum-base portion forms a part of a channel edge portion 2E defining the cooling channel on a side remote from the combustion chamber.

20. The piston according to claim 9, wherein the piston further comprises a resin portion 25 containing a resin material, and an iron-resin boundary portion 26 containing both the iron-base material and the resin material and provided between the iron-base portion and the resin portion by a prescribed thickness to join the iron-base portion and the resin portion to each other, and an outer peripheral part of the crown portion is formed with a cooling channel extending in a circumferential direction, the resin portion forming a channel edge portion defining the cooling channel, the iron-base portion forming a remaining part of the outer peripheral part of the crown portion excluding the channel edge portion.

21. The piston according to claim 9, wherein the piston further comprises a resin portion containing a resin material, and an aluminum-resin boundary portion containing both the aluminum-base material and the resin material and provided between the aluminum-base portion and the resin portion by a prescribed thickness to join the aluminum-base portion and the resin portion to each other, the aluminum-base portion forming an outer peripheral part of the skirt portions, the resin portion forming an inner peripheral part of the skirt portions.

22. A method for manufacturing a piston including a first portion containing a first material, a second portion containing a second material different from the first material, and a boundary portion containing both the first material and the second material and provided between the first portion and the second portion by a prescribed thickness to join the first portion and the second portion to each other, a composition ratio of the first material progressively decreasing and a composition ratio of the second material progressively increasing in the boundary portion from a side of the first portion to the second portion, the method comprising depositing layers containing the first material and the second material in different composition ratios and in molten state one after another with a progressively varying composition ratio of the first material and the second material.

23. The method for manufacturing a piston according to claim 22, wherein the first portion is formed as a single piece member by melt shaping or machining, the boundary portion is formed on a surface of the first portion, and the second portion is formed on a surface of the boundary portion as layers formed by melting the second material.

24. The method for manufacturing a piston according to claim 22, wherein the first portion is formed as a single piece member by melt shaping or machining, the boundary portion is formed on a surface of the first portion, and the second portion is formed as a single piece member by melt shaping or machining and attached to the boundary portion.

25. The method for manufacturing a piston according to claim 22, wherein the first portion is formed as a single piece member by melt shaping or machining, the second portion is formed as a single piece member by melt shaping or machining, and the boundary portion is formed as a single piece member and then attached to both the first portion and the second portion.
